(19) United States
(12) Patent Application Publication
(10) Pub. No.: US 2025/0272865 A1
(43) Pub. Date: Aug. 28, 2025

(54) Image-Assisted Material Classification for Mobile Dimensioning

(71) Applicant: ZEBRA TECHNOLOGIES CORPORATION, Lincolnshire, IL (US)

(72) Inventors: Michael Wijayantha Medagama, Nawala (LK); Gayani I. Chandrarathne, Yatiyantota (LK); Sanduni Karunatilaka, Kottawa (LK); Rochana Pathiraja, Dampelessa (LK)

(21) Appl. No.: 18/586,162

(22) Filed: Feb. 23, 2024

(51) Int. Cl. G06T 7/60; G06V 10/60; G06V 10/764

(52) U.S. Cl. CPC G06T 7/60; G06V 10/60; G06V 10/764

(57) ABSTRACT

A method in a computing device includes: capturing sensor data depicting a target object and an adjacent surface; detecting, from the sensor data, a first surface of the target object; identifying, from the sensor data, a material type of the adjacent surface; for a sample point on the first surface of the target object, determining a reflection intensity from the adjacent surface based on the material type determined from the sensor data; and selecting, based on the reflection intensity, a handling action from (i) determining an attribute of the target object and (ii) suppressing the determination of an attribute of the target object.

### BACKGROUND

Depth sensors such as time-of-flight (ToF) sensors can be deployed in mobile devices such as handheld computers, and employed to capture point clouds of objects (e.g., boxes or other packages), from which dimensions of the objects can be derived. Point clouds generated by ToF sensors, however, may include artifacts caused by multipath reflections received at the sensor.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a computing device for determining attributes of an object.

FIG. 2 is a diagram illustrating a multipath artifact in captured by the mobile computing device of FIG. 1.

FIG. 3 is a flowchart of a method of image-assisted material classification for mobile dimensioning.

FIG. 4 is a diagram illustrating a performance of block 305 of the method of FIG. 3.

FIG. 5 is a diagram illustrating an example performance of block 315 of the method of FIG. 3.

FIG. 6 is a diagram illustrating a example performance of block 320 of the method of FIG. 3.

FIG. 7 is a diagram illustrating a example performance of block 325 of the method of FIG. 3.

FIG. 8 is a diagram illustrating a example performance of block 355 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device, the method comprising: capturing sensor data depicting a target object and an adjacent surface; detecting, from the sensor data, a first surface of the target object; identifying, from the sensor data, a material type of the adjacent surface; for a sample point on the first surface of the target object, determining a reflection intensity from the adjacent surface based on the material type determined from the sensor data; and selecting, based on the reflection intensity, a handling action from (i) determining an attribute of the target object and (ii) suppressing the determination of an attribute of the target object.

Additional examples disclosed herein are directed to a computing device, comprising: a processor configured to: capture sensor data depicting a target object and an adjacent surface; detect, from the sensor data, a first surface of the target object; identify, from the sensor data, a material type of the adjacent surface; for a sample point on the first surface of the target object, determine a reflection intensity from the adjacent surface based on the material type determined from the sensor data; and select, based on the reflection intensity, a handling action from (i) determining an attribute of the target object and (ii) suppressing the determination of an attribute of the target object.

Further examples disclosed herein are directed to a non-transitory computer-readable medium storing computer-readable instructions executable by a processor of a computing device to: capture sensor data depicting a target object and an adjacent surface; detect, from the sensor data, a first surface of the target object; identify, from the sensor data, a material type of the adjacent surface; for a sample point on the first surface of the target object, determine a reflection intensity from the adjacent surface based on the material type determined from the sensor data; and select, based on the reflection intensity, a handling action from (i) determining an attribute of the target object and (ii) suppressing the determination of an attribute of the target object.

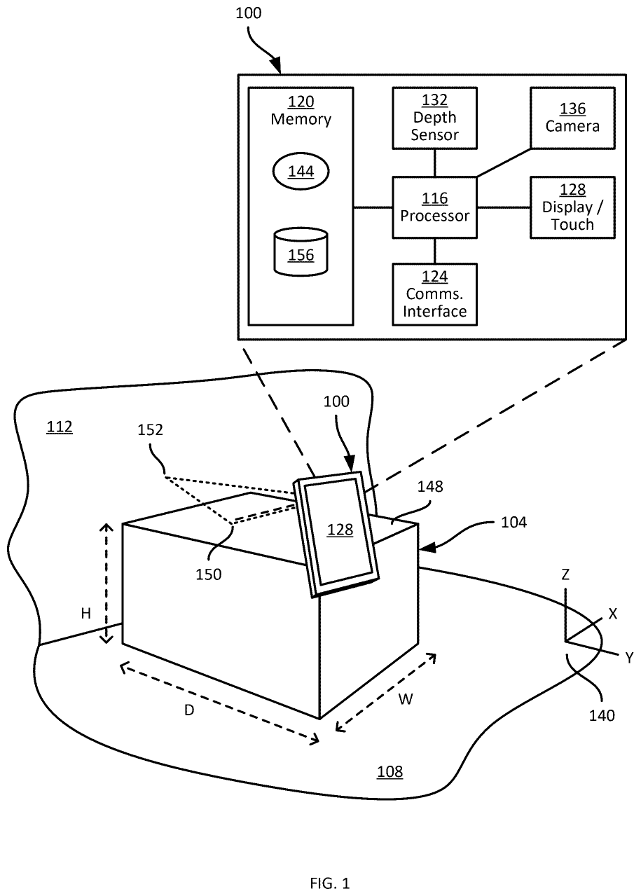

FIG. 1 illustrates a computing device 100 configured to capture sensor data depicting a target object 104 within a field of view (FOV) of a sensor of the device 100. The computing device 100, in the illustrated example, is a mobile computing device such as a tablet computer, smartphone, or the like. The computing device 100 can be manipulated by an operator thereof to place the target object 104 within the FOV of the sensor, in order to capture sensor data for subsequent processing as described below. In other examples, the computing device 100 can be implemented as a fixed computing device, e.g., mounted adjacent to an area in which target objects 104 are placed and/or transported (e.g., a staging area, a conveyor belt, a storage container, or the like).

The target object 104, in this example, is a parcel (e.g., a cardboard box or other substantially cuboid object), although a wide variety of other target objects can also be processed as set out below, including non-cuboid objects. The target object 104 is shown resting on a support surface 108 (e.g., a floor, table, conveyor, or the like), with an adjacent surface 112 nearby, such as a wall, a door, another parcel or stack of parcels, or the like.

The sensor data captured by the computing device 100 includes a point cloud and/or depth image. The point cloud includes a plurality of depth measurements (also referred to as points) defining three-dimensional positions of corresponding points on the target object 104. The sensor data captured by the computing device 100 also includes a two-dimensional (2D) image depicting the target object 104. The 2D image can include a two-dimensional array of pixels, each pixel containing a color and/or brightness value. For instance, the image can be a color image in which each pixel in the array contains a plurality of color component values (e.g., values for red, green and blue levels, or for any other suitable color model). From the captured sensor data, the device 100 (or in some examples, another computing device such as a server, configured to obtain the sensor data from the device 100) is configured to determine dimensions of the target object 104, such as a width “W”, a depth “D”, and a height “H” of the target object 104.

When the target object 104 is non-cuboid, the dimensions of the target object 104 need not align with physical edges of the object 104. For example, dimensions of an irregularly shaped object can be the width, depth, and height of a cuboid space encompassing the object 104, or the dimensions can include various other measurements of the object 104. The computing device 100 can further be configured to determine other attributes of the object 104 in addition to or instead of the dimensions noted above. For example, the computing device 100 can be configured to classify the object 104 into various types based on captured sensor data, to detect a location of the object 104, or the like.

The target object 104 is, in the examples discussed below, a substantially rectangular prism. As shown in FIG. 1, the height H of the object 104 is a dimension substantially perpendicular to a support surface (e.g., a floor) 108 on which the object 104 rests. The width W and depth D of the object 104, in this example, are substantially orthogonal to one another and to the height H. The dimensions determined from the captured data can be employed in a wide variety of downstream processes, such as optimizing loading arrangements for storage containers, pricing for transportation services based on parcel size, and the like.

Certain internal components of the device 100 are also shown in FIG. 1. For example, the device 100 includes a processor 116 (e.g., a central processing unit (CPU), graphics processing unit (GPU), and/or other suitable control circuitry, microcontroller, or the like). The processor 116 is interconnected with a non-transitory computer readable storage medium, such as a memory 120. The memory 120 includes a combination of volatile memory (e.g. Random Access Memory or RAM) and non-volatile memory (e.g. read only memory or ROM, Electrically Erasable Programmable Read Only Memory or EEPROM, flash memory). The memory 120 can store computer-readable instructions, execution of which by the processor 116 configures the processor 116 to perform various functions in conjunction with certain other components of the device 100. The device 100 can also include a communications interface 124 enabling the device 100 to exchange data with other computing devices, e.g. via various networks, short-range communications links, and the like.

The device 100 can also include one or more input and output devices, such as a display 128, e.g., with an integrated touch screen. In other examples, the input/output devices can include any suitable combination of microphones, speakers, keypads, data capture triggers, or the like.

The device 100 further includes a depth sensor 132, controllable by the processor 116 to capture point clouds. The device 100 also includes an image sensor, also referred to as a camera 136, configured to capture two-dimensional images, such as the color images mentioned above. In some examples, the depth sensor 132 and the camera 136 can be implemented by a single sensor device configured to capture both depth measurements for generating point clouds, and color and/or intensity measurements for generating 2D images.

The depth sensor 132 can include a time-of-flight (ToF) sensor, e.g., mounted on a housing of the device 100, for example on a back of the housing (opposite the display 128, which is visible in FIG. 1) and having an optical axis that is substantially perpendicular to the display 128. A ToF sensor can include, for example, a emitter (e.g., a laser emitter) configured to illuminate a scene, and an image sensor configured to capture light from the emitter as reflected by the scene. The ToF sensor can further include a controller configured to determine a depth measurement for each captured reflection, according to the time difference between illumination pulses and reflections. Each depth measurement indicates a distance between the depth sensor 132 itself and the point in space where the reflection originated. Each depth measurement represents a point in a resulting point cloud. The depth sensor 132 and/or the processor 116 can be configured to convert the depth measurements into points in a three-dimensional coordinate system 140. Although the coordinate system 140 is shown with an origin on the support surface 108, a wide variety of other coordinate systems can also be used, e.g., with an origin at the depth sensor 132.

As will be apparent to those skilled in the art, the depth sensor 132 can also be configured to generate 2D images, e.g., by capturing both the reflections from emitted light and ambient light, and generating a two-dimensional array of pixels containing intensity values. For illustrative purposes, however, 2D images processed in the discussion below are captured by the camera 136, e.g., simultaneously with the capture of point clouds by the depth sensor 132. The camera 136 may, in some examples, produce a 2D image with a greater resolution than the depth sensor 132 (e.g., with a greater number of pixels representing a given portion of the scene). The points of the point cloud can be mapped to corresponding pixels of the 2D image according to a transform defined by calibration data for the sensors 132 and 136 (e.g., sensor extrinsic and intrinsic matrices).

The memory 120 stores computer readable instructions for execution by the processor 116. In particular, the memory 120 stores a dimensioning application 144 which, when executed by the processor 116, configures the processor 116 to process one or more point clouds (e.g., one or more successive frames of depth measurements, converted to point clouds representing the target object 104 and surroundings at successive points in time) to detect the target object 104 and determine dimensions (e.g., the width, depth, and height shown in FIG. 1) and/or other attributes of the target object 104, such as an object type or class, an object location, or the like. For example, the dimensioning process implemented by the application 144 can include identifying a first surface of the object 104, such as an upper surface 148, as well as the support surface 108, in the point cloud. The height H of the target object 104 can be determined as the distance between the upper surface 148 and the support surface 108 (e.g., the perpendicular distance between the surfaces 148 and 108). The width W and the depth D can be determined as the dimensions of the upper surface 148.

Under some conditions, the point cloud captured by the depth sensor 132 can contain artifacts that impede the determination of accurate dimensions of the target object 104. For example, multipath artifacts can cause certain portions of the target object 104 to appear further from the sensor than those portions are in reality, which can lead to a point cloud containing a distorted representation of the target object 104.

An example multipath scenario is illustrated in FIG. 1, in which light emitted by the sensor 132 (shown in longer dashes) reflects from a point 150 on the upper surface 148 back towards the sensor 132, as well as from the point 150 towards a point 152 on the wall 112. At least a portion of the light reflected from the point 150 and impacting the point 152 may reflect (reflections are shown with shorter dashes) toward the sensor 132, such that the reflections received at the sensor 132 corresponding to the point 150 include both a reflection directly from the point 150, and a multipath reflection from the point 152. The reflections detected by the sensor 132 corresponding to the point 150 may therefore inflate the perceived distance from the sensor 132 to the point 150. Certain surfaces of the target object 104 may therefore appear curved or otherwise distorted in the point cloud.

The device 100 is therefore configured to implement additional functionality to detect when a point cloud captured via the sensor 132 (e.g., one frame of point cloud data) is likely to contain multipath artifacts sufficient to distort the appearance of the target object 104. The device 100 can further select handling actions for captured point clouds based on the above detection. For example, when the device 100 detects such artifacts, the device 100 can suppress dimensioning of the target object 104 based on the captured point cloud, e.g., to instead capture a further point cloud, generate a notification instructing an operator of the device 100 to move the target object 104, or the like. The functionality discussed herein can also be implemented via execution of the application 144 by the processor 116. In other examples, some or all of the functionality described herein can be performed via dedicated hardware (e.g., an application-specific integrated circuit or ASIC, or the like), or by a distinct computing device such as a server in communication with the device 100.

As discussed below, the additional functionality implemented by the device 100 includes identifying, from a two-dimensional image captured substantially simultaneously with the point cloud (e.g., via the camera 136), a material type of the wall 112 or any other adjacent surfaces to the target object 104. The device 100 can maintain, e.g., in the memory 120, a repository 156 of reflectivity coefficients for one or more material types. The device 100 can therefore, based on the identified material type of a surface adjacent to the target object 104 (such as the wall 112), determine a reflection intensity for reflections from the adjacent surface that may contribute to multipath artifacts in the point cloud. For example, the repository 156 can store, for each of a set of material types, a specular reflectivity coefficient, a specular exponent (also referred to as a shininess parameter), and a diffuse reflectivity coefficient.

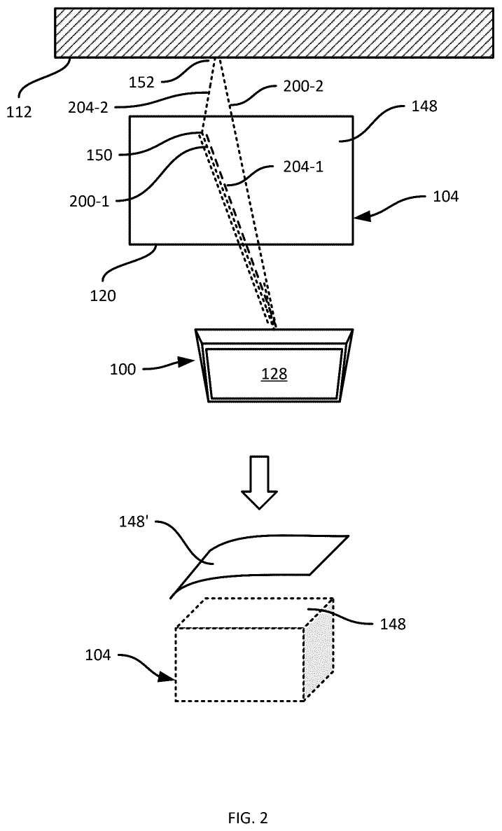

Referring to FIG. 2, an overhead view of the device 100, the target object 104, and the wall 112 is shown. Following emission of a pulse of illumination by the sensor 132, a single pixel of the sensor 132 may receive two distinct reflections. A first reflection 200-1 results directly from emitted light 204-1 impacting the point 150. A second reflection 200-2, however, results from a portion of the emitted light 204-1 generating a reflection 204-2 from the point 150 towards the point 152 on the wall 112, and then reflecting to the sensor 132. The sensor 132 can integrate the reflections 200 to generate an aggregated depth measurement corresponding to the point 150. Due to the variable nature of multipath reflections, however, it may be difficult to accurately determine the position of the point 150 in three-dimensional space. For example, the sensor may overestimate the distance between the sensor and the point 150. The resulting point cloud, for instance, may depict an upper surface 148′ that is distorted relative to the true shape of the upper surface 148 (the object 104 is shown in dashed lines below the surface 148′ for comparison). The surface 148′, in this exaggerated example, has a curved profile and is larger in one dimension than the true surface 148. Multipath artifacts in captured point clouds may therefore lead to inaccurate dimensions for the object 104.

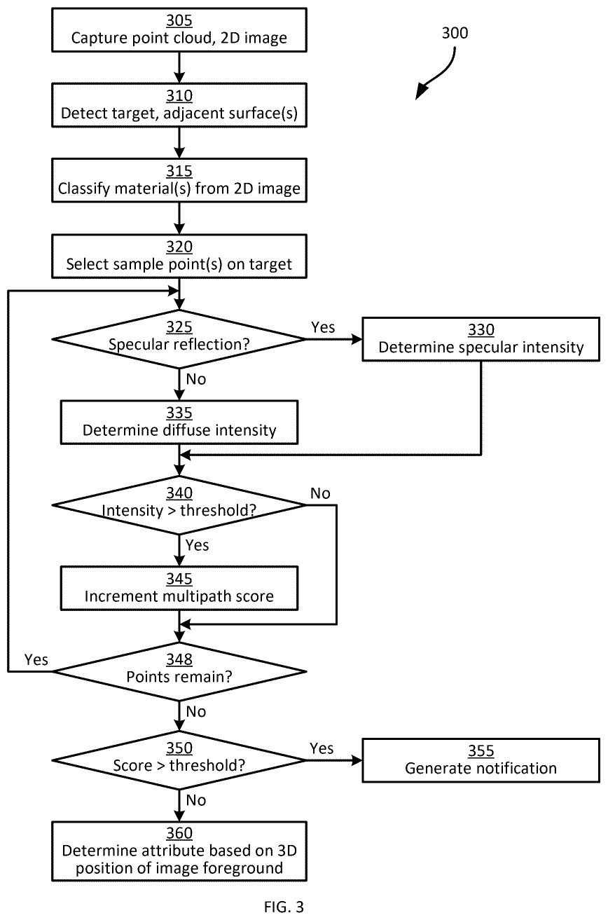

Turning to FIG. 3, a method 300 of image-assisted material classification for mobile dimensioning is illustrated. The method 300 is described below in conjunction with its performance by the device 100, e.g., to dimension the target object 104. It will be understood from the discussion below that the method 300 can also be performed by a wide variety of other computing devices including or connected with sensor assemblies functionally similar to the sensor assembly 132.

At block 305, the device 100 is configured, e.g., via control of the depth sensor 132 and the camera 136 by the processor 116, to capture a point cloud depicting at least a portion of the object 104, and a two-dimensional image depicting at least a portion of the object 104. The device 100 can, for example, be positioned relative to the object 104 as shown in FIG. 1, to capture a point cloud and image depicting the upper surface 148 and one or more other surfaces of the object 104. The point cloud and the 2D image are captured substantially simultaneously, e.g., by triggering the depth sensor 132 and the camera 136 at substantially the same time. In some examples, in which the depth sensor 132 and the camera 136 are implemented as a single sensor, simultaneous capture of the 2D image and the point cloud can be implemented by triggering such a combined sensor.

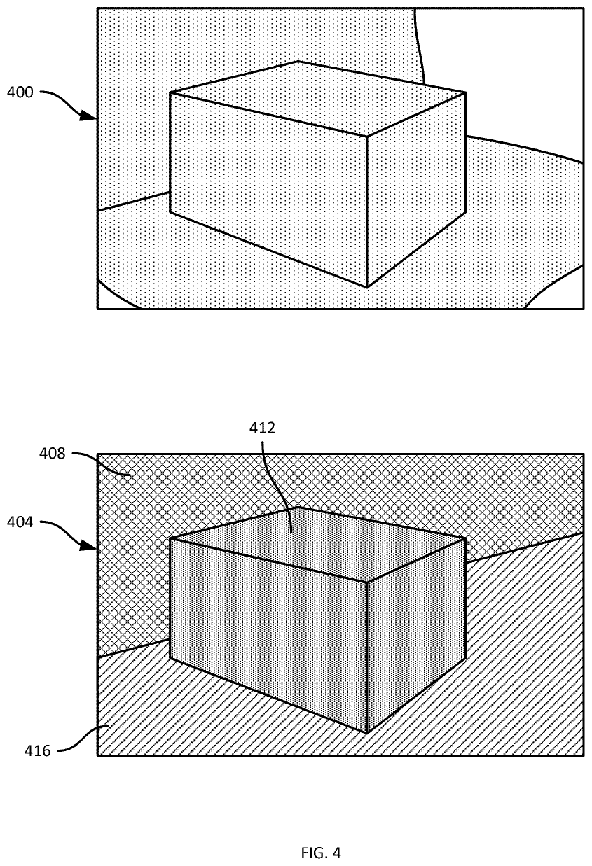

FIG. 4 illustrates an example point cloud 400 and an example image 404 captured at block 305. The point cloud 400 defines a plurality of points each having three-dimensional positions, e.g., specified in the coordinate system 140. Although outlines are shown for the object 104, the support surface 108, and the wall 112 for clarity, it will be understood that the point cloud 400 in practice does not include such outlines, object boundaries, or the like. The device 100 is instead configured, as discussed below, to distinguish objects in the point cloud from one another based on plane fitting operations and/or other suitable segmentation mechanisms. It will also be understood that the density of points in the point cloud 400 need not be consistent throughout the point cloud, as shown in FIG. 4. For example, certain regions of the point cloud 400 may have lower point densities than others.

The image 404 includes a plurality of pixels each having color and/or intensity values. The image 404 may include regions of similar color and/or intensity corresponding to distinct objects in the scene, e.g.,. as a result of the different materials constituting those objects. Such regions are indicated in FIG. 4 by different fill patterns, e.g., including a region 408 corresponding to the wall 112, a region 412 corresponding to the object 104, and a region 416 corresponding to the support surface 108. It will be understood that in reality a given surface (such as the wall 112) may not appear as consistently as shown in FIG. 4, due to shadows and other ambient lighting effects, variations in surface texture, and the like.

Returning to FIG. 3, at block 310 the device 100 is configured to detect at least one surface of the target object 104 in the point cloud 400. The device 100 can also detect other surfaces in the point cloud 400, such as the support surface 108 and the wall 112. In the present example, the device 100 is configured to detect at least the upper surface 148 of the target object 104, as well as the support surface 108 and the wall 112. The device 100 can also detect other surfaces of the object 104, such as the side and front surfaces visible in FIGS. 1 and 4.

To detect surfaces in the point cloud 400, the device 100 can be configured, e.g., via execution of the application 144, to perform a plane-fitting algorithm, such as random sample consensus (RANSAC), or the like. The support surface 108 can be distinguished from other surfaces during such detection by, for example, selecting the detected surface with the lowest height (e.g., the lowest Z value in the coordinate system 140). The upper surface 148 can be distinguished from other surfaces during detection by, for example, selecting a surface substantially parallel to the support surface 108 and/or substantially centered in the point cloud 400. The wall 112 can be distinguished from other surfaces in the point cloud 400 by its orientation (e.g., being substantially orthogonal to the support surface 108 and the upper surface 148). In some examples, the detection of the object 104 and/or other surfaces in the point cloud 400 can include processing the 2D image from block 305 via a machine-learning based object classifier, e.g., to obtain bounding boxes, masks, or the like corresponding to one or more of the object 104, the support surface 108, and the wall 112. Such bounding boxes can be used as inputs to plane fitting operations or the like.

At block 315, the device 100 is configured to identify, from the 2D image, a material type of at least one surface adjacent to the target object 104. For example, the application 144 can include an image classification model, or such a model can be implemented as a distinct application executable by the processor 116 and called via the application 144, for example. When executed by the processor 116, the segmentation model configures the processor 116 to select one of a set of predetermined material types for each of a plurality of regions in the image 404. For example, the processor 116 can assign a material type to each pixel of the image 404, resulting in regions of neighboring pixels with common material types. The model, such as a Region-based Convolutional Neural Network (R-CNN), a Fully Convolutional Network (FCN), or the like, can be trained with a set of images in which each pixel and/or other suitable region is labelled with material types.

The material types selected by the segmentation model can be determined during deployment of the application 144, for example, and can include materials likely to appear in the images captured at block 305. Example materials can include, for example, cardboard (e.g., if the object 104 is generally a cardboard box or other package), various support surface materials such as polished concrete, carpet or the like, and various wall surface materials, such as a matte white paint, or the like.

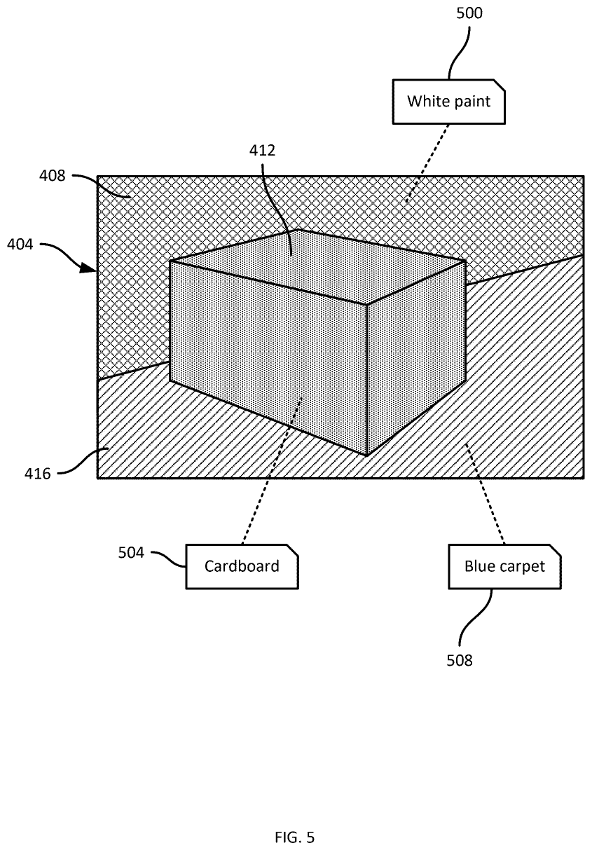

FIG. 5 illustrates an example result of the performance of block 315 for the image 404. In particular, each pixel of the image 404 can be labelled with one of the predetermined material identifiers mentioned above. In this example, a label 500 corresponds to a material identifier “white paint”, a label 504 corresponds to a material identifier “cardboard”, and a label 508 corresponds to a material identifier “blue carpet”. The labels 500, 504, and 508 need not be text strings in other examples, but can instead include numerical identifiers. Although the exact appearance of each pixel may vary, e.g., such that two pixels corresponding to the wall 112 may have difference color and/or intensity values, the segmentation model is configured to identify the appropriate material type (e.g., white paint, in this case) despite such differences. The output of block 315 can be a labelled version of the image 404, e.g., in which each pixel has a material type associated therewith.

Returning to FIG. 3, following the detection of object surfaces from the point cloud at block 310, and the identification of material types at block 315, beginning at block 320 the device 100 is configured to combine the detected surfaces and the identified material types to assess whether the point cloud captured at block 305 is likely to be affected by multipath artifacts to a degree sufficient to impede dimensioning of the target object 104.

At block 320, the device 100 is configured to select at least one sample point on a surface of the object 104, from the point cloud 400. In this example, the device 100 is configured to select one or more sample points on the surface 148 of the target object 104. In other examples, the device 100 can also select sample point(s) on other surfaces of the object 104 that are depicted in the point cloud 400.

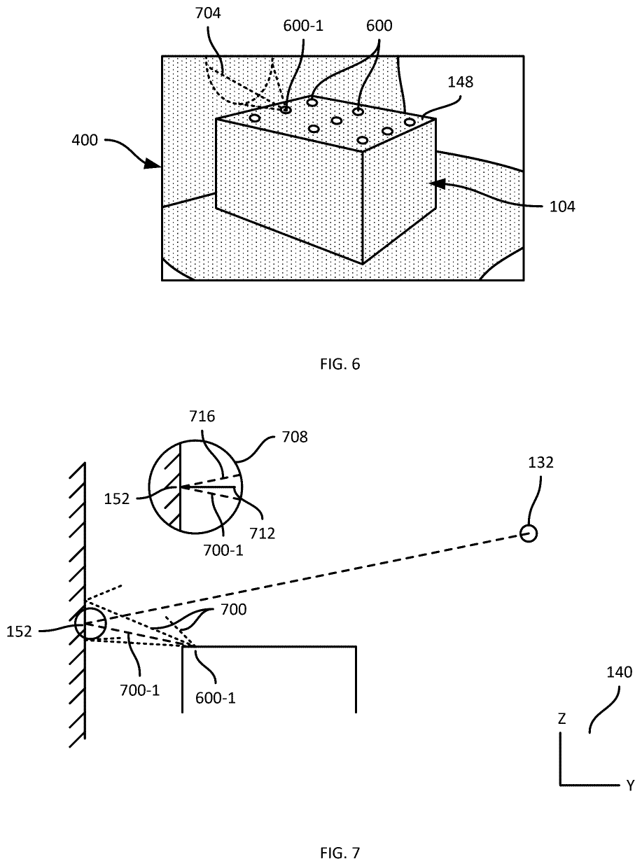

Turning to FIG. 6, the device 100 is configured to select a plurality of sample points 600, including a sample point 600-1 discussed in further detail below, on the upper surface 148 of the object 104. The sample points 600 can be selected to form a grid or other predetermined pattern, or can be selected randomly. The number of sample points 600 selected at block 320 can be predefined, e.g., as a configuration setting of the application 144. In other examples, the number of sample points 600 can be determined based on a sample point density setting, such that larger target objects 104 lead to larger numbers of selected sample points.

Referring again to FIG. 3, at blocks 325 to 345, the device 100 is configured to assess the sample points from block 320 and determine whether the sample points are likely to result in multipath artifacts in the point cloud 400. The assessment represented by blocks 325 to 345 is repeated for each sample point selected at block 320.

At block 325, the device 100 is configured to determine whether a specular reflection is likely to have originated at a surface other than the surface carrying the sample point, impacted the sample point, and contributed to light received at the depth sensor 132 from the sample point 600. As will be apparent, such a reflection may distort the position of the sample point 600 observed by the sensor 132.

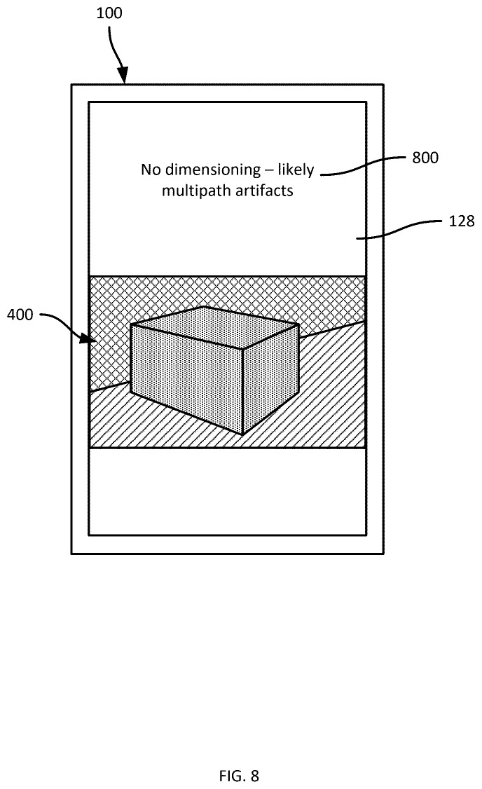

To perform block 325, the device 100 can be configured to determine whether a trajectory exists from the sensor 132, to a point on a surface distinct from the object 104 (e.g., the wall 112), to the sample point under consideration. Referring to FIG. 7, a side view of the wall 112 and a portion of the object 104 is shown, with the sample point 600-1 indicated. The device 100 can be configured to generate a plurality of rays 700 originating at the sample point 600-1. Four rays 700 are illustrated in FIG. 7, although it will be understood that a greater number of rays 700 can also be generated. For example, the device 100 can generate a plurality of rays distributed over a conical region 704 (illustrated in perspective view in FIG. 6) originating at the sample point 600-1.

The device 100 can generate a hemispherical region centered on the sample point 600-1, but as will be apparent, rays originating at the sample point 600-1 and travelling towards the sensor 132, rather than towards the wall 112 or any other surfaces, are unlikely to yield multipath reflections. Therefore, the computational load associated with reflection assessments for each ray can be reduced with little or no effect on the accuracy of the assessment by using a conical region, oriented away from the sensor 132 (e.g., oriented as shown in FIG. 6).

For each ray generated for the sample point 600-1, the device 100 is configured to determine whether the ray 700 impacts another surface represented in the point cloud. When that determination is negative, the ray 700 can be discarded. When the determination is affirmative, as in the case of the four example rays 700 shown in FIG. 7, which all impact the wall 112, the processor 116 is configured to determine whether a ray between the sensor 132 and the point of impact is likely to generate a reflection that coincides with the ray 700 under consideration. In other words, the processor 116 determines whether an angle between a normal of the wall 112 and a ray from the sensor 132 to the point of impact is substantially equal to an angle between the normal and the ray 700 (e.g., within a predetermined threshold). Alternatively, the processor 116 can determine a reflection vector for the ray 700 at the impacted point, and then determine whether the reflection vector intersects the sensor 132.

As seen in FIG. 7, particularly in the detail view 708, the processor 116 can determine an angle between the ray 700-1 and a normal vector 712 of the wall 112 (at the point 152), and can also determine a reflection vector 716 corresponding to the ray 700-1. The reflection vector 716, which has an equal angle to the normal 712 as the ray 700-1, intersects the sensor 132. The ray 700-1 therefore is a potential source of a specular reflection from the point 152 of the wall 112. The other example rays 700 shown in FIG. 7, however, are not potential sources of specular reflections at the wall 112.

For any ray(s) that are potential sources of specular reflections, at block 330 the device 100 is configured to determine a specular reflection intensity for those rays. The determination of a specular reflection intensity can be made according to the following specular reflection model:

$${I}_{spec} = {K}_{s} {{I}_{p} ( cos θ )}^{n} \qquad Equation ( 1 )$$

In equation (1) above, Ispec is the intensity of a specular reflection, Ks is a specular reflectivity coefficient of the wall 112 (or any other surface impacted by a ray 700), Ip is the intensity of the light source (that is, the emitter of the sensor 132). Further, the angle θ (theta) is the angle between the normal 712 and the ray 700, and the constant n is the specular exponent, also referred to as a shininess parameter. The intensity of the light source can be retrieved from manufacturer data for the sensor 132 stored in the memory 120. The angle θ is derived from the point cloud 400 and the relevant one of the rays 700. The specular reflectivity coefficient and the specular exponent are retrieved from the repository 156, based on a material type identified at block 315. In particular, the processor 116 is configured to determine which pixel of the image 404 corresponds to the point 152 (in this example) impacted by the ray 700-1, based on the transform defined by calibration data for the sensors 132 and 136 as mentioned earlier. The processor 116 is then configured to determine which material type was identified for the corresponding pixel of the 2D image, and to retrieve the specular reflectivity coefficient and specular exponent for that material type from the repository 156. As will be apparent from equation (1), the intensity of a specular reflection, for a given material, decreases for shallower impact angles.

When the determination at block 325 is negative, the processor 116 determines a diffuse reflection intensity for the ray 700 under consideration. Diffuse reflection intensity can be made according to the following diffuse reflection model:

$${I}_{diff} = {K}_{d} {I}_{p} cos θ \qquad Equation ( 2 )$$

In equation (2) above, Idiff is the intensity of a diffuse reflection, Kd is a diffuse reflectivity coefficient of the wall 112 (or any other surface impacted by a ray 700). As in equation (1), Ip is the intensity of the light source and θ (theta) is the angle between the normal 712 and the ray 700. As will now be apparent, the diffuse reflectivity coefficient can be retrieved for the corresponding material type from the repository 156.

Following block 330 (if the determination at block 325 was affirmative) or block 335 (if the determination at block 325 was negative), the device 100 proceeds to block 340. At block 340, the device 100 is configured to determine whether the intensity from block 330 or 335 exceeds an intensity threshold. The threshold can be a predetermined intensity, e.g., in candela or any other suitable unit of measurement. When the determination at block 340 is negative for the current ray, the processor 116 is configured to continue processing the remaining rays for the current sample point 600, as well as any remaining sample points 600.

When the determination at block 340 is affirmative, at block 345 the device 100 is configured to increment a multipath artifact score corresponding to the point cloud. In other words, the multipath artifact score is incremented for each ray originating from each sample point that is likely to produce a sufficiently intense multipath reflection. The device 100 then continues processing the remaining rays 700 and sample points 600, until each ray 700 of each sample point 600 has been processed. In other examples, the determination at block 340 can be made once all of the rays for a given sample point are assessed, such that the threshold applied at block 340 represents an aggregated reflection intensity for a given sample point. The multipath score can therefore be incremented once for each sample point 600, based on the collected reflection intensities determined for that sample point 600.

Following block 345, or following a negative determination at block 340, the device 100 is configured, at block 348, to determine whether any sample points 600 remain to be processed. When the determination at block 348 is affirmative, the device 100 returns to block 325 to process the next sample point. When the determination at block 348 is negative, indicating that all sample points 600 have been processed as described above, the device 100 proceeds to block 350.

At block 350, the device 100 is configured to determine whether the multipath artifact score accumulated through multiple performances of blocks 325 to 345 exceeds a predetermined threshold. The processor 116 is configured to select a handling action for the point cloud 400 based on the determination at block 350. In particular, the processor 116 is configured to select between dimensioning the target object 104 using the point cloud 400, and suppressing dimensioning of the target object 104 until a further point cloud is captured (e.g., in the next frame of data from the depth sensor 132 and the camera 136).

When the determination at block 350 is affirmative, the potential contributions of multipath reflections from adjacent surfaces such as the wall 112 are sufficient that the accuracy of the point cloud 400 may be negatively affected, and the device 100 can suppress dimensioning of the object 104 using the point cloud 400. Instead, the device 100 may generate a notification, e.g., on the display 128, an audible tone, as a message to another computing device, or the like, indicating that dimensioning has been suppressed. FIG. 8 illustrates an example notification 800 generated at block 355. In other examples, the notification can include an instruction to an operator of the device 100 to reposition the object 104 away from nearby surfaces.

At block 360, in response to a negative determination at block 350, the device 100 can proceed to determine one or more attributes of the object 104, such as dimensions of the object 104, for presentation on the display 128, transmission to another computing device, processing via a further application executed by the device 100, or the like.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device, the method comprising:
capturing sensor data depicting a target object and an adjacent surface;
detecting, from the sensor data, a first surface of the target object;
identifying, from the sensor data, a material type of the adjacent surface;
for a sample point on the first surface of the target object, determining a reflection intensity from the adjacent surface based on the material type determined from the sensor data; and
selecting, based on the reflection intensity, a handling action from (i) determining an attribute of the target object and (ii) suppressing the determination of the attribute of the target object.

2. The method of claim 1, wherein determining the material type of the adjacent surface includes:
executing a segmentation model to determine, for each pixel of the two-dimensional image, one of a set of predetermined material types; and
storing the determined material type for each pixel.

3. The method of claim 2, further comprising:
storing, for each of the predetermined material types, a reflectivity coefficient; and
determining the reflection intensity based on the stored reflectivity coefficient for the material type of the adjacent surface.

4. The method of claim 3, wherein storing the reflectivity coefficient includes storing a specular reflectivity coefficient and a diffuse reflectivity coefficient; and
selecting, based on an angle of incidence of a ray between the sample point and the adjacent surface, between the specular reflectivity coefficient and the diffuse reflectivity coefficient; and
determining the reflection intensity based on the selected one of the specular reflectivity coefficient and the diffuse reflectivity coefficient.

5. The method of claim 1, further comprising:
in response to selecting determining the attribute of the target object:
determining dimensions of the target object from the point cloud based on the first surface; and
presenting the dimensions on a display of the computing device.

6. The method of claim 1, further comprising:
in response to selecting suppressing the determination of the attribute of the target object, generating a notification indicating that the point cloud likely contains multipath artifacts.

7. The method of claim 1, further comprising:
determining reflection intensities for each of a plurality of sample points on the first surface;
incrementing a multipath score for each reflection intensity that exceeds a first threshold; and
selecting the handling action by comparing the multipath score to a second threshold.

8. The method of claim 7, wherein selecting the handling action includes selecting suppressing dimensioning of the target object when the multipath score exceeds the second threshold.

9. The method of claim 1, wherein the sensor data includes a point cloud and a two-dimensional image; and
wherein the first surface of the target object is detected from the point cloud, and the material type of the adjacent surface is determined from the two-dimensional image.

10. A computing device, comprising:
a processor configured to:
capture sensor data depicting a target object and an adjacent surface;
detect, from the sensor data, a first surface of the target object;
identify, from the sensor data, a material type of the adjacent surface;
for a sample point on the first surface of the target object, determine a reflection intensity from the adjacent surface based on the material type determined from the sensor data; and
select, based on the reflection intensity, a handling action from (i) determining an attribute of the target object and (ii) suppressing the determination of the attribute of the target object.

11. The computing device of claim 10, wherein the processor is configured to determine the material type of the adjacent surface by:
executing a segmentation model to determine, for each pixel of the two-dimensional image, one of a set of predetermined material types; and
storing the determined material type for each pixel.

12. The computing device of claim 11, wherein the processor is further configured to:
store for each of the predetermined material types, a reflectivity coefficient; and
determine the reflection intensity based on the stored reflectivity coefficient for the material type of the adjacent surface.

13. The computing device of claim 12, wherein the processor is further configured to:
store, for each of the predetermined material types, a specular reflectivity coefficient and a diffuse reflectivity coefficient; and
select, based on an angle of incidence of a ray between the sample point and the adjacent surface, between the specular reflectivity coefficient and the diffuse reflectivity coefficient; and
determine the reflection intensity based on the selected one of the specular reflectivity coefficient and the diffuse reflectivity coefficient.

14. The computing device of claim 10, wherein the processor is further configured to:
in response to selecting suppressing the determination of the attribute of the target object, generate a notification indicating that the point cloud likely contains multipath artifacts.

15. The computing device of claim 10, wherein the processor is further configured to:
determine reflection intensities for each of a plurality of sample points on the first surface;
increment a multipath score for each reflection intensity that exceeds a first threshold; and
select the handling action by comparing the multipath score to a second threshold.

16. The computing device of claim 15, wherein the processor is configured to select the handling action by selecting suppressing the determination of the attribute of the target object when the multipath score exceeds the second threshold.

17. The computing device of claim 10, wherein the sensor data includes a point cloud and a two-dimensional image; and
wherein the first surface of the target object is detected from the point cloud, and the material type of the adjacent surface is determined from the two-dimensional image.

18. A non-transitory computer-readable medium storing computer-readable instructions executable by a processor of a computing device to:
capture sensor data depicting a target object and an adjacent surface;
detect, from the sensor data, a first surface of the target object;
identify, from the sensor data, a material type of the adjacent surface;
for a sample point on the first surface of the target object, determine a reflection intensity from the adjacent surface based on the material type determined from the sensor data; and
select, based on the reflection intensity, a handling action from (i) determining an attribute of the target object and (ii) suppressing the determination of the attribute of the target object.
